(19) United States
(12) Patent Application Publication
(10) Pub. No.: US 2009/0106467 A1
(43) Pub. Date: Apr. 23, 2009

(54) MULTIPROCESSOR APPARATUS

(75) Inventors: Shinji Kashiwagi, Kanagawa (JP); Hiroyuki Nakajima, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC Electronics Corporation, Kanagawa (JP)

(21) Appl. No.: 12/175,700

(22) Filed: Jul. 18, 2008

(30) Foreign Application Priority Data
Jul. 20, 2007 (JP) 2007-189770

(51) Int. Cl. G06F 13/368

(52) U.S. Cl. 710/120

(57) ABSTRACT

Disclosed is a multiprocessor apparatus including a co-processor provided in common to a plurality of processors and including a plurality of resources and an arbitration circuit that arbitrates contention among the processors with respect to use of a resource in the co-processor by the processors through a co-processor bus, which is a tightly coupled bus, for each resource or each resource hierarchy according to instructions issued from the processors to the co-processor. Under control by the arbitration circuit, simultaneous use of a plurality of resources on a same hierarchy or different hierarchies in the co-processor by the processors through the tightly coupled bus is allowed.

### REFERENCE TO RELATED APPLICATION

This application is based upon and claims the benefit of the priority of Japanese patent application No. 2007-189770 filed on Jul. 20, 2007, the disclosure of which is incorporated herein in its entirety by reference thereto.

### TECHNICAL FIELD

The present invention relates to an apparatus including a plurality of processors. More specifically, the invention relates to a system configuration suitable for being applied to an apparatus in which co-processor resources are shared by the processors.

### BACKGROUND

A typical configuration example of a multiprocessor (parallel processor) system of this type will be shown in FIG. 9 (refer to Non-Patent Document 1). The multiprocessor (parallel processor) system includes a plurality of symmetrical or asymmetrical processors and co-processors. In this system, a memory and a peripheral 10 are shared by the processors.

Co-processors (co-processors) are classified into the following two types:

co-processors that assists processors by taking charge of specific processing (audio, video, or wireless processing, or an arithmetic operation such as a floating-point arithmetic or an arithmetic operation of an FET (Fast Fourier Transform) or the like); and

co-processors that serve as hardware accelerators that perform whole processing necessary for the specific processing (audio, video, wireless processing, or the like)

In the multiprocessor including plurality processors, a co-processor may be shared by the processors like the memory, or the co-processor may be exclusively used locally by a processor.

An example shown in FIG. 9 is a configuration in which a co-processor is exclusively used locally by a processor. Then, an example of an LSI configuration using a configurable processor MeP (Media embedded Processor) technique is shown.

An audio CODEC MeP module in FIG. 9 supports processors. As the co-processor that performs an arithmetic operation of a VLIW (Very Long Instruction Word) instruction, which lacks in an Mep core (basic processor), an audio VLIW co-processor is added. As the VLIW instruction, a general-purpose arithmetic instruction such as multiplication and accumulation is added and defined, thereby accelerating audio CODEC processing. A hardware engine for a video filter is provided as a video filter module and functions an accelerator. Circuit resources within the module are used only for the video filter.

FIG. 10 is a simplified diagram for explaining the configuration in FIG. 9. As shown in FIG. 10, a processor 201A and a processor 201B are tightly coupled to co-processors 203A and 203B for specific applications through local buses for the processors, respectively. Local memories 202A and 202B store instructions which are executed by the processors 201A and 201B and working data, respectively.

A parallel processing device of a configuration in which a multiprocessor and peripheral hardware (composed of co-processors and various peripheral devices) connected to the multiprocessor are efficiently emphasized is disclosed in Patent Document 1. FIG. 11 is a diagram showing a configuration of a CPU disclosed in Patent Document 1. Referring to FIG. 11, there are provided a plurality of processor units P0 to P3 each of which executes a task or a thread. Also provided a CPU 10 connected to co-processors 130a and 130b and peripheral hardware composed of peripheral devices 40a to 40d. Each processor unit that executes a task or a thread asks the peripheral hardware to process the task or thread according to execution content of the task or thread being executed. FIG. 12 is a simplified diagram of the configuration in FIG. 11. As shown in FIG. 12, the processors P0 to P3, and co-processors 130a and 130b are connected to a common bus. Then, the processors P0 to P3 access the co-processors 130a and 130b through the common bus.

[Patent Document 1] JP Patent Kokai Publication No. JP-P2006-260377A

[Non-Patent Document 1] Toshiba Semiconductor Product Catalog General Information on Mep (Media embedded Processor) Internet URL: <http://www.semicon.toshiba.co.jp/docs/calalog/ja/BCJ0043_catalog.pd f>

### SUMMARY

The entire disclosures of Patent Document 1 and Non-Patent Document 1 are incorporated herein by reference thereto. The following analysis is given by the present invention.

The configuration of the related art described above has the following problems.

In the configurations shown in FIGS. 9 and 10, when the processors are tightly coupled to the local buses for the co-processors, respectively, other processor on the common bus cannot access the co-processors.

Further, the processors 201A and 201B locally have circuits (such as a computing unit and a register) necessary for the co-processors 203A and 203B, respectively. Thus, it becomes difficult to perform sharing with other processor at a co-processor (computational resource) level or sharing of circuit resources at a circuit level such as the computing unit and the register.

The co-processor is tightly coupled to a co-processor IF (interface) for each processor locally, and hence the co-processor specialized in a certain function cannot be used by other processor. In the case of the configuration shown in FIG. 9, a dedicated module for each specific application is provided. Circuit resources in each module are difficult to use for other application.

The hardware engine such as the video filter module described above, for example, cannot be used for other application.

When the hardware engine cannot be used due to a defect (a failure or a fault), it becomes difficult to provide alternative means without degrading processing performance as little as possible.

It may be conceived that for instance the audio CODEC module that accelerates processing according to the VLIW instruction is adopted as the alternative means. However, simultaneous audio processing will be interfered.

On the other hand, when the co-processors are arranged on the common bus, as shown in FIG. 12, all the processors can access the co-processors. Sharing of co-processor resources is thereby allowed. However, sharing of the co-processor resources is through the common bus that is also used for accesses to a shared memory and the peripheral IOs. Thus, when an access is made to a low-speed memory or a low-speed IO, bus traffic or a load tends to be influenced. For this reason, this configuration is inferior in real-time performance.

The invention is generally configured as follows.

A multiprocessor device according to one aspect of the present invention includes: a co-processor provided in common to a plurality of processors and including a plurality of resources; and an arbitration circuit for arbitrating contention among the processors for each resource or each hierarchy of a plurality of resources according to instructions issued from the processors to the co-processor.

In the present invention, the co-processor variably sets connecting relationships among resources according to an instruction issued from the processor to the co-processor.

In the present invention, the tightly coupled bus may include a multi-layer bus through which the processors access the co-processor through different layers, respectively.

In the present invention, under control by the arbitration circuit, simultaneous use of a plurality of mutually contention free resources on a same hierarchy or different hierarchies in the co-processor by the processors through the tightly coupled bus is allowed.

In the present invention, extended instructions that exclusively use one or a plurality of resources in the co-processor may be provided as an instruction set; and when the extended instructions are simultaneously issued from the processors to the co-processor, contention on the basis of the one or the plurality of the resources corresponding to the extended instructions may be arbitrated by the arbitration circuit.

In the present invention, the extended instructions may include:

first-layer extended instructions corresponding to unit functions of circuit resources, respectively; and

second-layer extended instructions each of which implements a predetermined function by combining a plurality of the circuit resources corresponding to the first-layer extended instructions. The extended instructions may further include third-layer extended instructions each of which implements a predetermined function by combining the circuit resources corresponding to the second-layer extended instructions.

In the present invention, the co-processor may include:

an interface circuit that interfaces with each of the processors through a tightly coupled bus;

a decoder that interprets a command supplied from each of the processors through the tightly coupled bus;

a control circuit that controls a function of the co-processor according to a signal resulting from decoding of the command;

circuit resources including arithmetic circuits and register files; and

multiplexers arranged on input/output buses of the circuit resources. The control circuit may output a selection signal specifying connecting destinations of the multiplexers.

According to the present invention, use of an auxiliary processor through a bus different from a common bus for the processors is arbitrated. One auxiliary processor can be used by the processors, and a higher-speed operation as compared with a case in which accesses are made through the common bus can also be achieved. This feature of the present invention is suited for real-time processing.

Further, according to the present invention, arbitration of contention is performed for each hierarchically defined instruction as well as for each circuit resource. A higher-level solution to the contention is thereby allowed. Further, when a top-layer instruction is desired to be changed, a programming change using a medium-layer or lower-layer instruction can be made. A hardware change can be thereby avoided.

Still other features and advantages of the present invention will become readily apparent to those skilled in this art from the following detailed description in conjunction with the accompanying drawings wherein examples of the invention are shown and described, simply by way of illustration of the mode contemplated of carrying out this invention. As will be realized, the invention is capable of other and different examples, and its several details are capable of modifications in various obvious respects, all without departing from the invention. Accordingly, the drawing and description are to be regarded as illustrative in nature, and not as restrictive.

### BRIEF DESCRIPTIONS OF THE DRAWINGS

FIG. 1 is a drawing showing a schematic configuration of a first example of the present invention;

FIG. 2 is a drawing showing a configuration of a co-processor in a second example of the present invention;

FIG. 3 is a diagram showing a configuration example of a co-processor in a third example of the present invention;

FIG. 4 is a diagram showing a configuration example of a co-processor in a fourth example of the present invention;

FIG. 5 is a diagram showing an operation example of the fourth example of the present invention;

FIGS. 6A and 6B are diagrams for explaining presence or absence of access contention in a tightly coupled bus;

FIGS. 7A and 7B are diagrams for explaining presence or absence of access contention in a loosely coupled bus;

FIG. 8 is a diagram for explaining presence or absence of access contention in a tightly coupled bus;

FIG. 9 is a diagram showing a configuration of a related art;

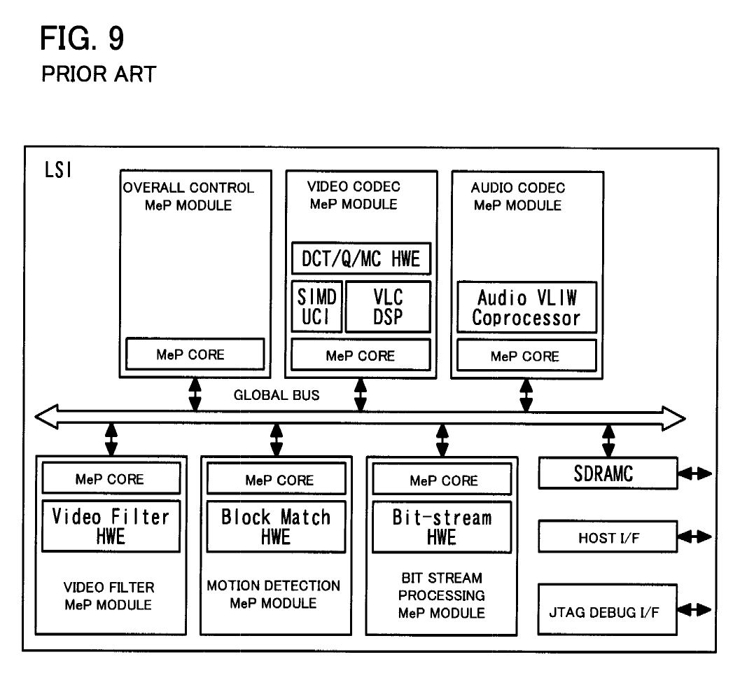

FIG. 10 is a diagram explaining the configuration in FIG. 9;

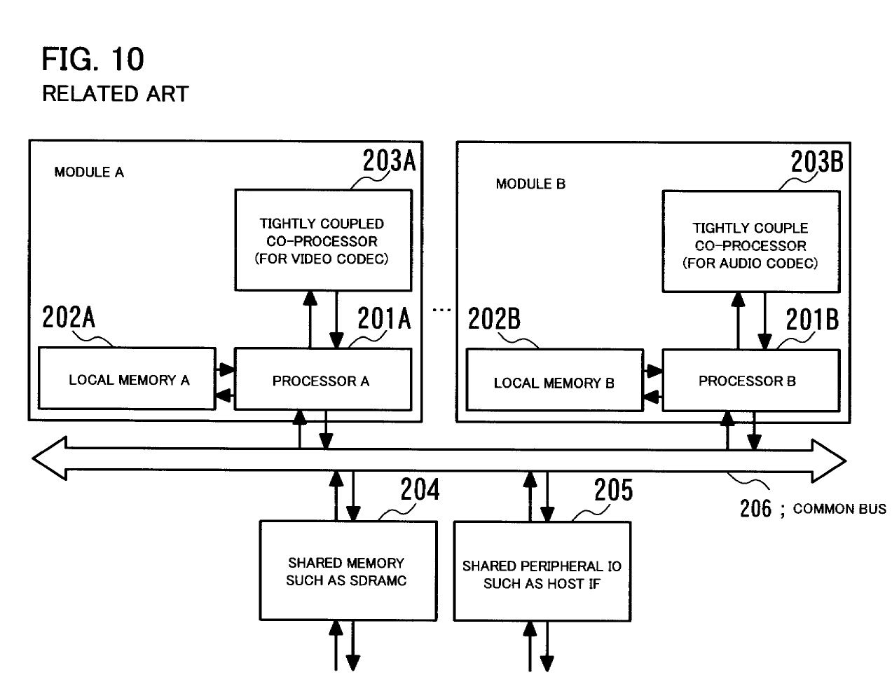

FIG. 11 is a diagram showing a configuration of a related art; and

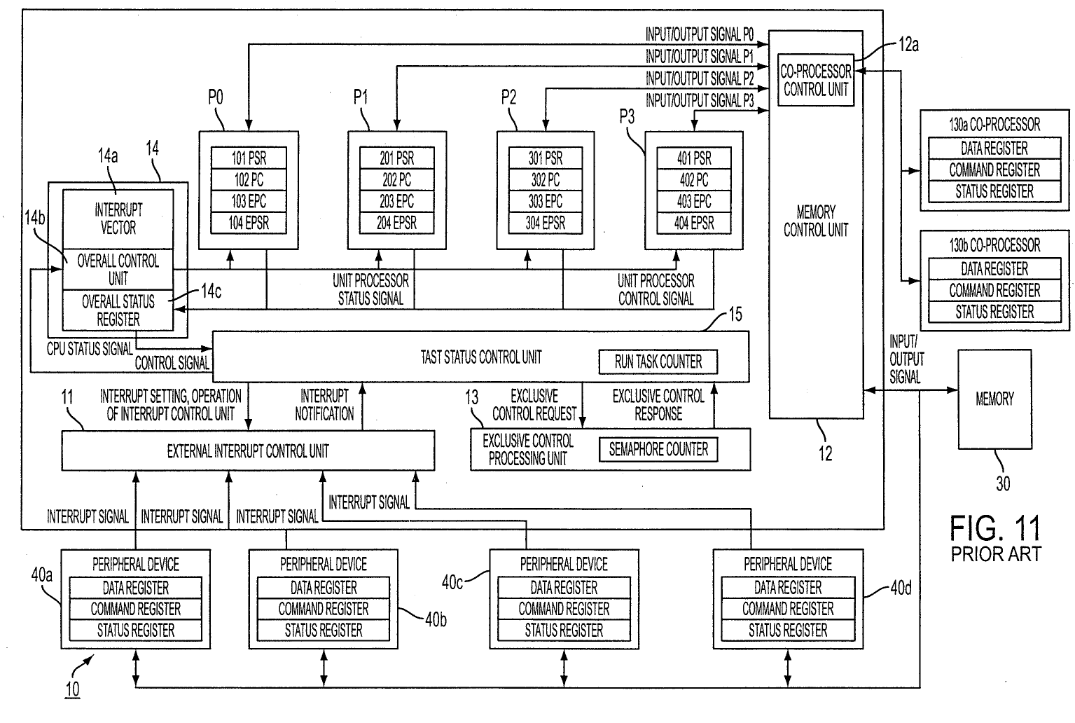

FIG. 12 is a diagram explaining the configuration in FIG. 11.

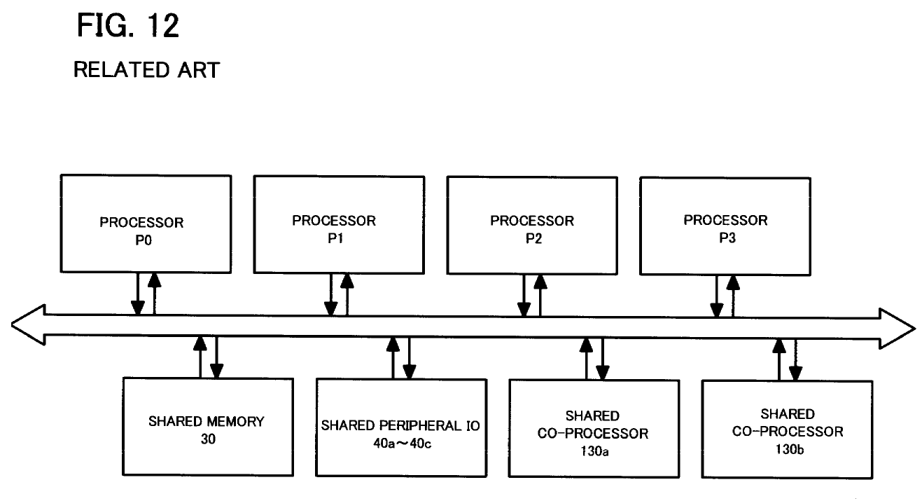

### PREFERRED MODES OF THE INVENTION

The present invention will be described in further detail with reference to drawings. In an exemplary embodiment of the present invention, as an approach to classifying circuit resources in a co-processor by ALUs (Arithmetic Logic Units), register files and the like which are handled by an RT (Register Transfer) level, co-processor instructions (also referred to as extended co-processor instructions) that exclusively use the resources are provided.

In an exemplary embodiment of the present invention, a processor is connected to the co-processor through a tightly coupled bus. An arbitration circuit performs arbitration of contention for a resource to be used. In this example, co-processor instructions simultaneously issued from a plurality of processors, for example, are executed in parallel within the co-processor when there is no contention for a resource among the co-processor instructions.

In an exemplary embodiment of the present invention, as a method in which the circuit resources in the co-processor are classified by the ALUs and the register files to be handled by the RT (Register Transfer) level, extended co-processor instructions are hierarchically defined as follows, for example:

lower-layer extended co-processor instructions defined to implement a unit function such as arithmetic four-rules calculation or memory transfer;

medium-layer extended co-processor instructions which implement functions capable of being diverted for general purpose between different applications by a combination of at least a plurality of the circuit resources; and

upper-layer extended co-processor instructions limited to specific applications which are implemented by a combination of the circuit resources that form the medium-layer extended co-processor instructions.

In an exemplary embodiment of the present invention, a co-processor that implements the features described above includes, as resources:

a bus interface circuit (a tightly coupled bus interface circuit) for interfacing with a processor;

a decoder circuit that interprets an instruction (command) such as an opcode supplied from a tightly coupled bus;

a control circuit that controls a function of the co-processor according to a signal resulting from decoding the instruction (command);

circuit resources classified by ALUs and register files to be handled by the RT level;

multiplexers arranged on input/output buses of the respective circuit resources; and

a mode signal (a selection signal) that specifies connecting destinations of the multiplexers

According to the state of the mode signal (selection signal) output by the control circuit, connecting destinations of the input/output buses of the circuit resources in the co-processor are changed. Implementation of various hierarchically defined co-processor instructions thereby becomes possible.

A bus through which a command (a co-processor instruction) and a signal indicating a pipeline status are transferred is referred to as the “tightly coupled bus”. The co-processor connected to the processors through the tightly coupled bus is also referred to as a “tightly coupled co-processor”. A bus through which connection among each processor, a memory, peripheral 10, and the like is established and through which an address, a control signal and data are transferred is referred to as a “loosely coupled bus”.

### FIRST EXAMPLE

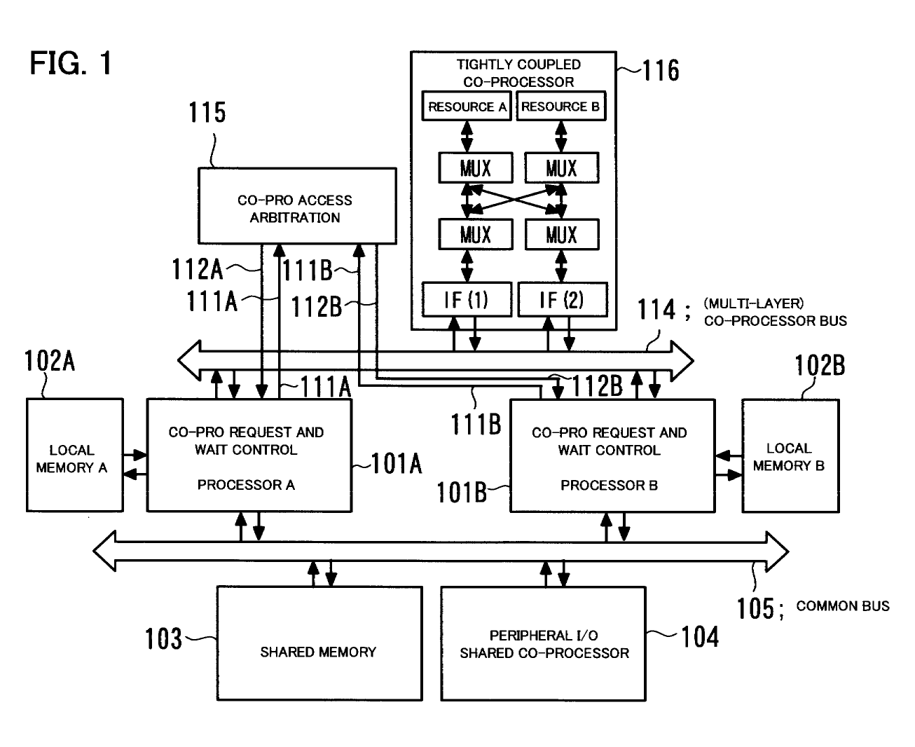

FIG. 1 is a diagram showing a configuration of a first example of the present invention. Referring to FIG. 1, a plurality of processors 101A and 101B that form parallel processors are connected to a shared memory 103 and a peripheral 10 (such as a shared co-processor) 104 through a common bus 105. The processors 101A and 101B are respectively connected to exclusive memories (local memories) 102A and 102B through local buses other than the common bus 105. By taking charge of specific (audio, video, wireless or the like) processing, a co-processor 116 assists the processors. In this example, the co-processor 116 is shared between the processors 101A and 101B through a co-processor bus (a multi-layer bus) 114. Further, an arbitration circuit (a co-pro access arbitration circuit) 115 that arbitrates contention for a resource in the co-processor 116 between the processors 101A and 101B is provided.

In this example, the co-processor 116 includes co-processor bus interfaces IF-(1) and IF-(2), and is connected to the multi-layer co-processor bus 114. The multi-layer co-processor bus 114 is the bus that allows simultaneous accesses from a plurality of processors.

The arbitration circuit (co-pro access arbitration circuit) 115 receives requests 111A and 111B to use a resource in the co-processor 116 from the processors 101A and 101B, respectively. When the requests to use the same resource are overlapped, use of the resource in the co-processor 116 by one of the processors is permitted, and use of the resource in the co-processor 116 by the other of the processors is waited for, using signals 112A and 112B.

In the co-processor 116, each of a resource A and a resource B includes multiplexers (MUXs) on each input/output bus thereof, to which an access can be made through individual layers of the multi-layer bus 114.

A signal from the interface IF-(1) is transferred to the resource A or B through an MUX directly coupled to the interface IF-(1) and an MUX in the next stage. A signal from the interface IF-(2) is transferred to the resource A or B through an MUX directly coupled to the interface IF-(2) and an MUX in the next stage.

A signal from each of the resources A and B is transferred to the interface IF-(1) or IF-(2) through the multiplexers. Four multiplexers MUX constitute a matrix switch that switches connection between two ports connected to the interfaces and two 10 ports connected to the resources A and B.

Accesses to the resources A and B in the co-processor 116 can be made from different layers of the co-processor bus 114, respectively. Thus, even when requests to use the co-processor 116 are overlapped between the processors 101A and 101B, the requests will not contend if destinations of the requests are different, or if one request is for the resource A and the other request is for the resource B. Simultaneous use of the co-processor 116 is thereby possible.

On the other hand, when requests to use the same resource in the co-processor 116 from the processors 101A and 101B are overlapped, the arbitration circuit (co-pro access arbitration circuit) 115 permits use of the resource in the co-processor 116 by one of the processors, and for the request to use the resource in the co-processor 116 by the other of the processors, the arbitration circuit 115 causes the use to be waited for.

According to this example, when requests to use the co-processor 116 from the processors 101A and 101B are overlapped, the request will not content if destinations of the requests are different as being the resources A and B, respectively. Simultaneous use of the co-processor 116 thereby becomes possible. When requests to use the resource A contend, or when requests to use the resource B contend, the arbitration circuit 115 causes one of the requests to be waited for.

Referring to FIG. 1, the number of the interfaces IF is not of course limited to two. In FIG. 1, the resources A and B are illustrated, for simplicity. The present invention is not, however, limited to such a configuration. A configuration further including a resource on an upper layer overlaying the resources A and B may be of course employed. Such a resource includes a multiplexer MUX on an input/output bus thereof.

### SECOND EXAMPLE

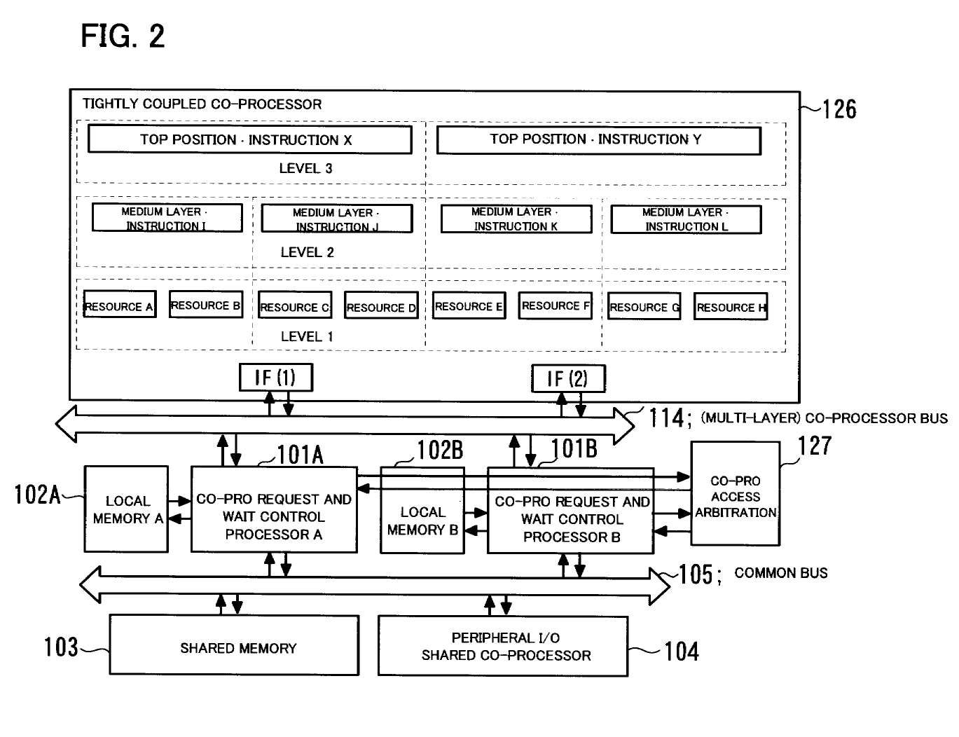

Next, a second example of the present invention will be described. FIG. 2 is a diagram showing the concept about hierarchical design of co-processor instructions in this example. A co-processor configuration shown in FIG. 2 is different from the co-processor configuration shown in FIG. 1 in a manner of classification of co-processor resources.

Referring to FIG. 2, as an approach to classify circuit resources in the co-processor 126 by ALUs, register files and the like which are handled by an RT (Register Transfer) level, there are provided co-processor instructions (extended co-processor instructions) hierarchically classified as follows:

lower-layer extended co-processor instructions defined to implement a unit function such as arithmetic four-rules calculation or memory transfer;

medium-layer extended co-processor instructions which implement functions capable of being diverted for general purpose between different applications by a combination of at least a plurality of lower-layer circuit resources; and

upper-layer extended co-processor instructions limited to specific applications that are implemented by a combination of the circuit resources that form the medium-layer extended co-processor instructions. In other words, a hierarchical structure is introduced into the co-processor instructions.

In FIG. 2, for example, instructions that can be implemented by substantially the same number of cycles and arithmetic circuits as common processor instructions such as a multiply and accumulate instruction and a shift instruction are defined as level 1 (lower-layer) instructions. This level 1 instruction is implemented by each of resources A to H.

Instructions that implement signal processing such as an FFT (Fast Fourier Transform) by a combination of the level 1 instructions such as the multiply and accumulate instruction are defined as level 2 (medium-layer) instructions. Medium-layer instructions I to L correspond to the level 2 instructions.

Instructions that implement a DCT (Discrete Cosine Transform) and an IDCT by a combination of level 2 instructions such as those for the FFT and an IFFT (Inverse FFT) are defined as level 3 (upper-layer) instructions. Top-layer instructions X to Y correspond to these level 3 instructions. In the present invention, the number of layers for hierarchization is not of course limited to three.

For the level 2 and level 3 instructions, a sequencer or a finite state machine (FSM) using hardware in the co-processor 126 controls the circuit resources A to H, thereby performing processing of a function as the level 2 or 3 instruction.

In the level 2 instructions, for example,

the medium-layer instruction I is formed by the resources A and B,

the medium-layer instruction J is formed by the resources C and D,

the medium-layer instruction K is formed by the resources E and F, and

the medium-layer instruction L is formed by the resources G and H.

Further, in the level 3 instructions,

the top-layer instruction X is formed by the resources A to D, and

the top-layer instruction Y is formed by the resources E to H.

As described above, the circuit resources that form the extended co-processor instructions in the respective layers differ in the co-processor 126, and depending on a combination of a plurality of instructions that have been issued, requests to use the circuit resource in the co-processor 126 may not be overlapped. When the requests to use the circuit resource according to a plurality of extended co-processor instructions issued from a plurality of processors do not contend, simultaneous execution of the co-processor instructions becomes possible.

### THIRD EXAMPLE

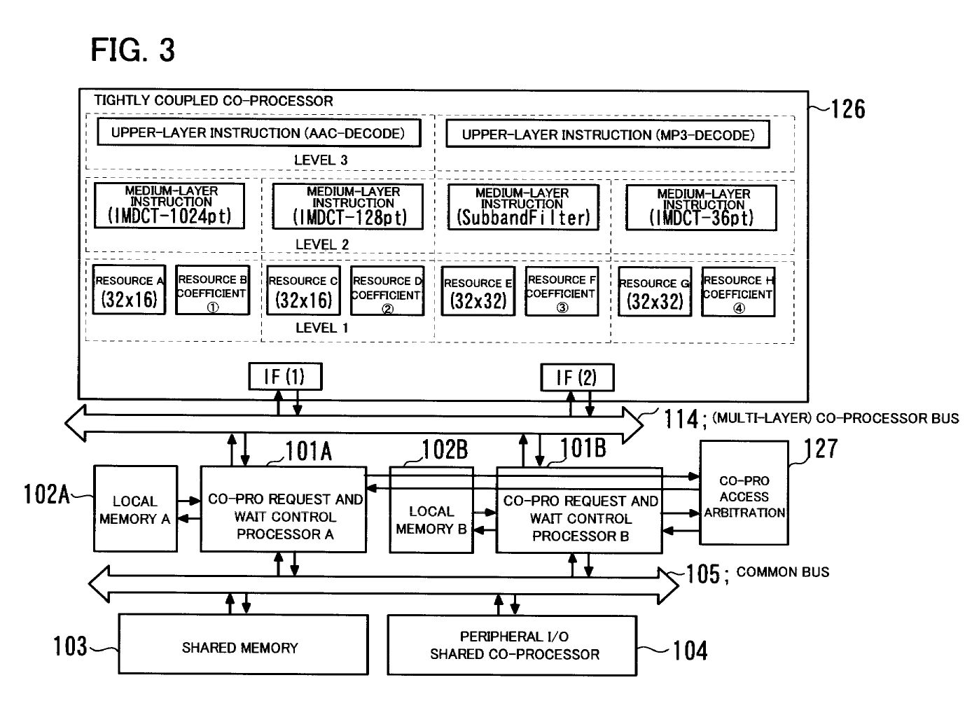

A third example of the present invention will be described. FIG. 3 is a diagram showing a configuration of a multi-standard (format) compressed audio decoder according to this example. Referring to FIG. 3, a co-processor 126 on the left side of a longest broken line in the co-processor 126 is used for AAC (Advance Audio Coding), while the right side of the longest broken line is used for MP3 (MPEG1 Audio Layer-3). A signal processing method and operation accuracy needed for each audio decoding differ, and computing units and coefficient tables needed for respective audio decoding are provided as resources A to H.

The resources A and B are, for example, circuit resources for processing a 1024-point IMDCT (Inverse Modified Discrete Cosine Transform) necessary for AAC decoding.

The resource A is a 32×16 multiplier, while the resource B is a coefficient table for the 1024-point IMDCT.

In order to perform processing of the AAC decoding, it is enough to execute an upper-layer (AAC-decode) instruction. However, when only the upper-layer (AAC-decode) instruction is defined, and when the decode processing is desired to be changed, the change is not easy because sequence control is performed by hardware (or it is necessary to change the hardware).

Then, in this example, level 1 instructions using the resources A to D and medium-layer instructions for the 1024-point IMDCT and a 128-point IMDCT are defined, and AAC-decode processing software using the medium-layer instructions is constructed. A change in the decode processing is thereby facilitated.

According to this example, the circuit resources of the co-processor may be diverted. For this reason, performance deterioration is more reduced than replacement with a processor instruction.

### FOURTH EXAMPLE

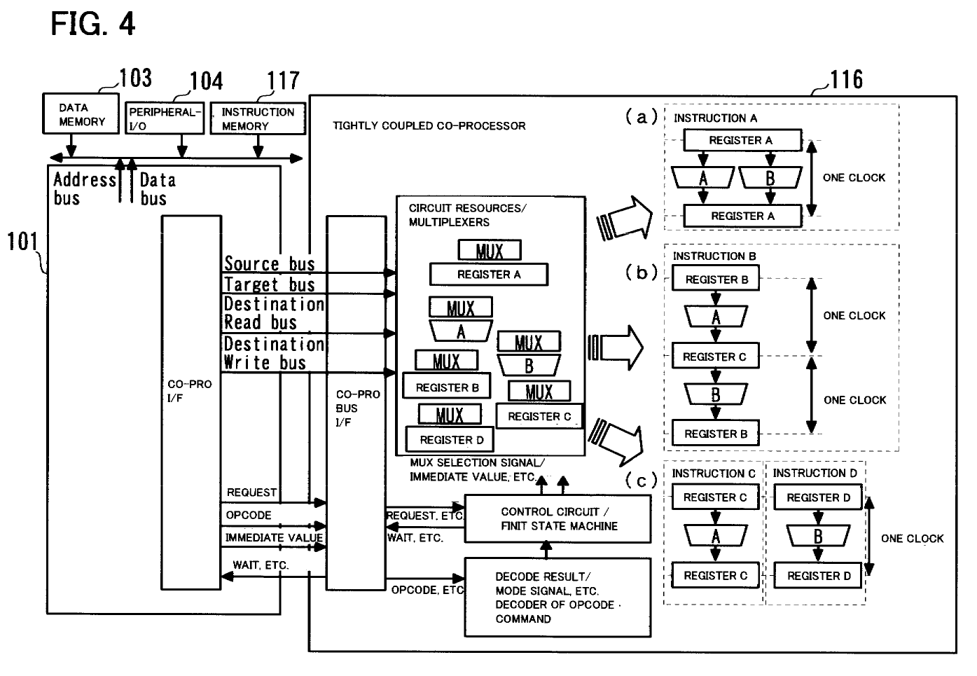

A fourth example of the present invention will be described. FIG. 4 is a diagram showing the configuration of a co-processor according to this example. In the configuration shown in FIG. 4, a function of the arbitration circuit 115 in FIG. 1 is implemented in a control circuit in a co-processor 116.

The co-processor includes:

a co-processor bus interface (I/F) circuit (also referred to as a “tightly coupled bus interface circuit”) for interfacing with a processor;

a decoder circuit that interprets an instruction (a command) such as an opcode supplied from a tightly coupled bus;

a control circuit that controls a function of the co-processor according to a signal resulting from decoding of the instruction (command);

circuit resources classified by ALUs and register files to be handled by an RT level; and

multiplexers arranged on an input/output bus of each circuit resource. Connecting destinations of the multiplexers are set according to a mode signal (a selection signal) from the control circuit.

More specifically, in this example, connecting destinations of input/output buses of the circuit resources in the co-processor 116 are changed according to the state of the mode signal (selection signal) output by the control circuit in the co-processor 116. Implementation of various hierarchically defined extended co-processor instructions is thereby allowed.

To the co-processor bus interface, a source bus, a target bus, a destination read bus, and a destination write bus are connected. Further, a request, an instruction (opcode), and immediate data from a processor 101, a wait state, a pipeline state, and the like from the co-processor 116 are transferred to the co-processor bus interface.

The circuit resources and multiplexers correspond to the resources A and B and the multiplexers in FIG. 1, respectively. The control circuit/FSM (Finite State Machine) supplies an MUX selection signal, an immediate value, and the like to the circuit resources/multiplexers, receives a request from the processor 101, and sends out a WAIT signal to the processor 101 when contention for the resource occurs.

The decoder decodes the opcode and the command transferred from the processor 101.

FIG. 4 shows circuit configuration changes when three types of extended co-processor instructions are executed.

In an instruction A, processing that causes computing units A and B to operate in parallel is performed in one clock cycle, as shown in a broken line portion (a) on the upper right in the page of FIG. 4.

In an instruction B, execution of the instruction is performed using two clock cycles as shown in a broken line portion (b) on the middle right in the page of FIG. 4 as follows: the computing unit A is operated in a first clock cycle, and a result of the operation is stored in a register A, and the computing unit B is operated in a second clock cycle, and a result of the operation is stored in a register B.

A broken line portion (c) indicates a state where an instruction C using the computing unit A and an instruction D using the computing unit B are simultaneously executed.

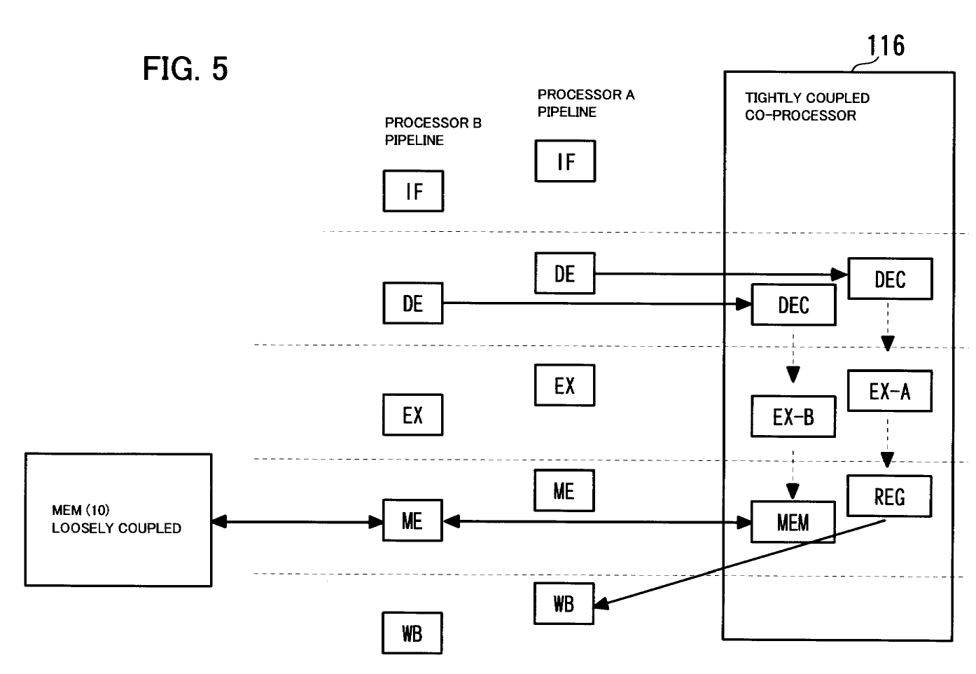

FIG. 5 is a diagram showing pipe line transitions when co-processor instructions are simultaneously issued from a processor A and a processor B, respectively, as an example. In this example, a command (instruction) sent from each of the processors A and B to the co-processor is composed of level 1 through 3 instructions. The co-processor that has received a co-processor instruction transferred from the processor may start operation from a decode (DE) stage, and may return a result of the operation executed in an operation executing (EX) stage to the processor in a memory access (ME) stage.

In the example shown in FIG. 5, the co-processor instructions simultaneously issued by the processors A and B may be simultaneously executed in the co-processor 116 because no contention for a circuit resource in the co-processor 116 is present. More specifically, the co-processor instructions fetched by the processors A and B are transferred to the co-processor 116 in the respective decode (DE) stages of the processors A and B, and simultaneously executed in parallel through two pipelines, for example, in the co-processor 116. Alternatively, respective stages of the pipelines may be executed by time division in the co-processor 116.

The operation result of the co-processor instruction issued by the processor A and executed by the co-processor 116 is stored in a register (REG) after an operation executing (EX-A) stage of the co-processor 116. Then, in the memory access (ME) stage of the processor A, the operation result is returned to the processor A. Then, in a write-back (WB) stage, the operation result is stored in a register of the processor A.

The operation result of the co-processor instruction issued by the processor B and executed by the co-processor 116 is stored in a memory (MEM) after an operation executing (EX-B) stage of the co-processor 116. Then, in the memory access (ME) stage of the processor B, the operation result is returned to the processor B. Then, in a write-back (WB) stage, the operation result is stored in a register of the processor B. A memory access to a data memory in the memory access (ME) stage of the processor or the like is performed through a loosely-coupled bus.

Among the co-processor instructions, there are various co-processor instructions such as a co-processor instruction that needs an operation in the EX stage alone, a co-processor instruction that needs an operation up to the MEM stage, and a co-processor instruction that needs an operation from the DE stage. When no contention for a circuit resource used by those instructions is present, a plurality of co-processors instructions may be simultaneously executed.

According to this example, computational resources of the co-processor tightly coupled to local buses of the processors may be shared by the processors. Sharing of the computational resources of the co-processor and high-speed access using tight coupling can be achieved at the same time.

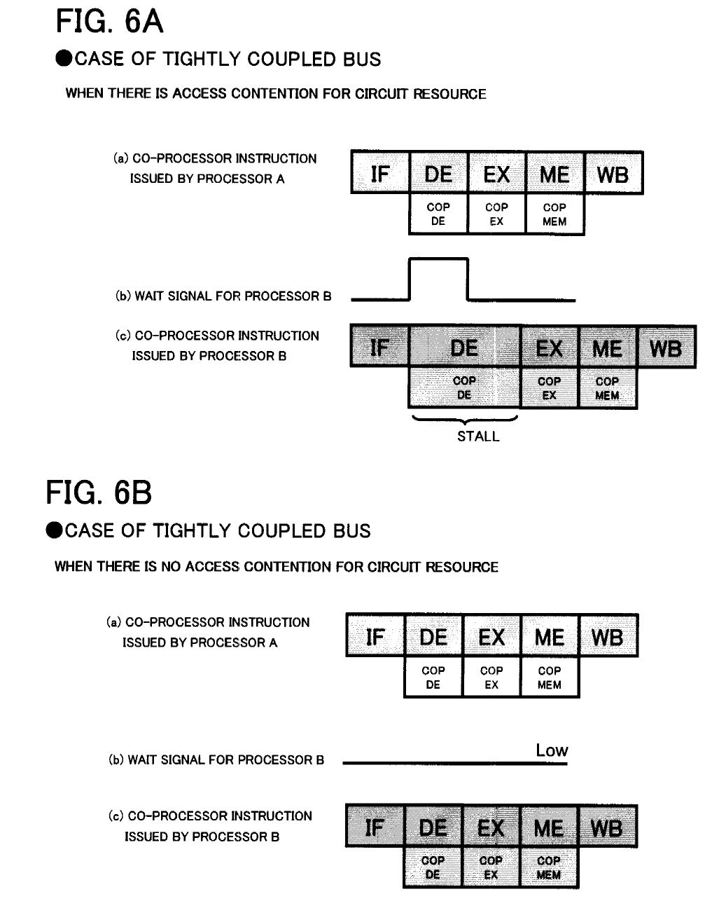

Next, referring to FIG. 6, arbitration of co-processor accesses through the tightly-coupled bus in this example will be described. Though no particular limitation is imposed, an instruction pipeline in this example includes five stages: an instruction fetch (IF) stage, a decode (DE) stage, an operation executing (EX) stage, a memory access (ME) stage, and a result storage (WB) stage. In the case of a load instruction, for example, address calculation is performed in the EX stage. Data is read from the data memory in the ME stage. Then, read data is written to the register in the WB stage. In the case of a store instruction, address calculation is performed in the EX stage. Data is written into the data memory in the ME stage. Then, no operation is performed in the WB stage.

Referring to FIG. 6A, the processor A fetches an instruction from a local memory (or an instruction memory included in the processor A) (in the (IF) stage). Then, when the fetched instruction is determined to be a co-processor instruction in the decode (DE) stage, the processor A outputs a request to use the co-processor to an arbitration circuit (indicated by reference numeral 115 in FIG. 1) in order to cause the instruction to be executed by the co-processor. The processor A receives from the arbitration circuit permission to use, and sends the instruction to the co-processor. The co-processor executes respective stages of decoding (COP DE), instruction execution (COP EX), and memory access (COP ME: also termed as COP MEM) of the instruction received from the processor A. Then, the write-back (WB) stage by the processor A is executed. Though no particular limitation is imposed, in the memory access (COP ME) stage of the co-processor, a result of the instruction execution (an operation result) by the co-processor may be transferred to the processor A through a local bus of the processor A, and may be written to the register in the processor A in the write-back (WB) stage of the processor A. In this case, the processor A receives the operation result from the co-processor instead of the data memory, and stores the result in the register in the WB stage. In an example shown in FIG. 6A, the instruction pipeline stages (DE, EX, ME) of each processor are synchronized with the instruction pipeline stages (COP DE, COP EX, COP ME) of the co-processor that executes the co-processor instruction issued by the processor. Operating frequencies for the co-processor and the processor may be of course different. Alternatively, the co-processor may operate asynchronously with the processor, and when the co-processor finishes an operation, a READY signal may be notified to the processor.

The processor B also causes respective stages of decoding (COP DE), instruction execution (COP EX), and memory access (COP ME) of an instruction to be executed by the co-processor. In this case, the arbitration circuit (indicated by reference numeral 115 in FIG. 1) causes the processor B to be in a wait state during a period corresponding to the decode (DE) stage of the co-processor instruction (corresponding to the DE stage of the co-processor instruction issued by the processor A), and the decode (DE) stage of the co-processor instruction issued by the processor B is stalled. Then, waiting (WAITING) is released. The processor B receives permission to use (release of the WAITING) from the arbitration circuit, and sends the instruction to the co-processor. The co-processor sequentially executes the respective stages of decoding (COP DE), instruction execution (COP EX), and memory access (COP ME) of the instruction received from the processor B. Then, the write-back (WB) stage by the processor B is executed.

FIG. 6A shows the example where contention for a circuit resource occurs in the instruction decode (DE) stage of the co-processor (e.g. where the co-processor instructions simultaneously issued by the processors A and B are the same). An object, for which access contention is subjected to arbitration is not limited to the instruction decode (DE) stage. When contention for a circuit resource in the co-processor occurs in each of the operation executing (EX) stage and the memory access (ME) stage, use of the circuit resource in the co-processor by the processor other than the processor in which the use is permitted is set to the wait state.

On the other hand, when there is no access contention for a circuit resource in co-processor instructions issued by the processors A and B, respectively, the WAIT signal remains inactive (LOW), as shown in FIG. 6B. In the co-processor, pipeline stages from the decode (DE) stages to the memory access (ME) stages of the co-processor instructions from the processors A and B are simultaneously executed. Though no limitation is imposed, in the examples in FIGS. 6A and 6B, the co-processor 116 may have a configuration in which two pipelines are included, thereby allowing simultaneous issuance of two instructions.

In this example, adjustment of contention for a circuit resource in the co-processor tightly coupled to the processors is made for each instruction pipeline stage. To the arbitration circuit 115 in FIG. 1, information on a pipeline stage progress (current stage) of the co-processor 116 is notified through the co-processor bus 114, for example. The arbitration circuit 115 performs control of monitoring use of a corresponding resource and determines whether contention will occur in the resource requested to use. That is, it may be so arranged that a signal indicating a pipeline status of the co-processor 116 or the like is transferred to the tightly coupled bus from the co-processor 116. In this case, the pipeline status or the like is notified to the processors 101A and 101B through the co-processor bus 114.

The arbitration circuit 115 that arbitrates contention for a resource through the tightly coupled bus performs arbitration of resource contention for each pipeline stage. The arbitration of contention for the resource in the co-processor 116 among the processors may be of course performed for each instruction cycle, rather than each pipeline stage.

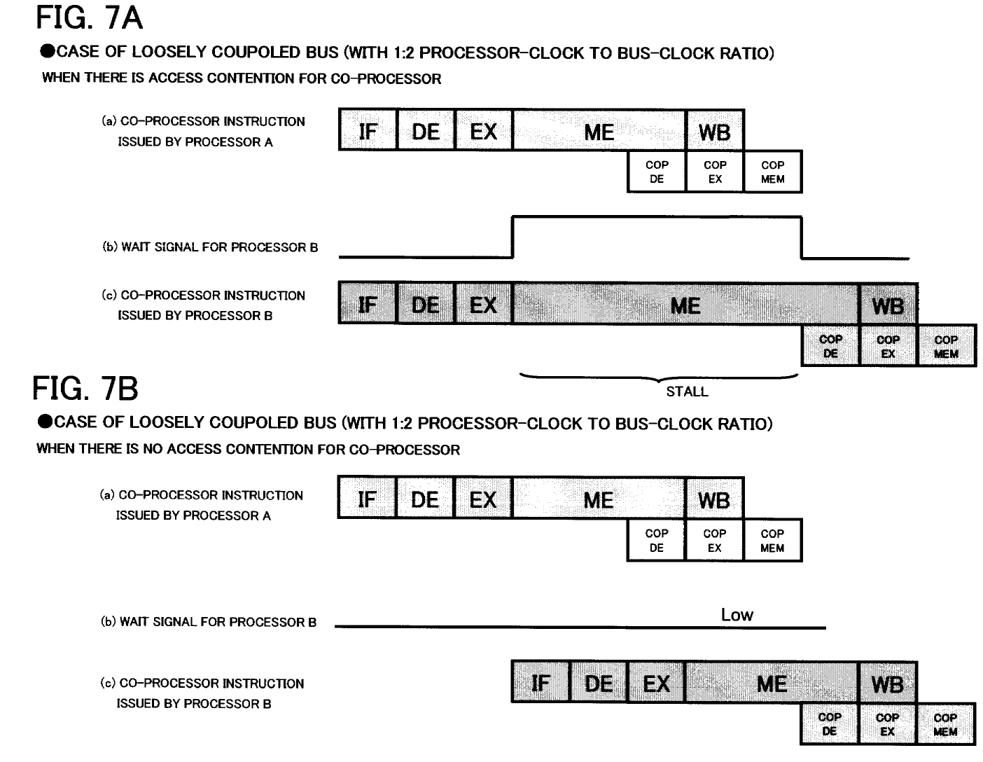

FIGS. 7A and 7B are diagrams showing instruction pipeline transitions when the processors are connected to the co-processor through a loosely coupled bus such as a common bus, as comparative examples.

When each processor delivers an instruction to the co-processor through the loosely coupled bus such as the common bus, the instruction is delivered to the co-processor in the memory access (ME) stage of the instruction pipeline of the processor. In a latter half of the memory access (ME) stage of the processor, decoding (COP DE) of the instruction is performed in the co-processor. In a cycle corresponding to the write back (WB) stage of the processor, the operation executing (EX) stage of the co-processor is executed, and then, the memory access (COP ME) stage is executed. Though no particular limitation is imposed, in the memory access (COP ME) stage of the co-processor, data transfer from the co-processor to the processor is made. In examples shown in FIG. 7A, the speed of a bus cycle of the loosely coupled bus such as the common bus is low. Thus, a stall period occurs in the processor pipeline by a bus access. During a period corresponding to the memory access (COP ME) stage of the co-processor, a vacancy of the processor pipeline is generated.

When the memory access (ME) stages of the processors A and B contend as shown in FIG. 7A, the memory access (ME) stage of the processor B (accordingly, the DE stage where the co-processor instruction is transferred to the co-processor and the co-processor decodes the co-processor instruction) is brought into a standby state until the stages of decoding (COP DE), instruction execution (COP EX), and memory access (COP ME) of the co-processor instruction issued by the processor A are completed in the co-processor. That is, through the loosely coupled bus such as the common bus, the memory access (COP ME) stage of the co-processor that executes the instruction issued by the processor A and the memory access (ME) stage of the processor B contend for a resource through the bus. Thus, the memory access (ME) stage of the processor B is stalled until the stages of decoding (COP DE), instruction execution (COP EX) and memory access (COP ME) of the instruction issued by the processor A are completed.

After completion of the memory access (COP ME) stage of the instruction issued by the processor A in the co-processor, waiting of the memory access (ME) stage of the processor B is released. Responsive to this release, the co-processor instruction issued by the processor B is transferred to the co-processor. Then, in the co-processor, respective stages of decoding (COP DE), execution (COP EX), and memory access (COP ME) of the co-processor instruction issued by the processor B are sequentially executed.

Where there is no access contention for a circuit resource in co-processor instructions issued from the processors A and B, a wait (WAIT) signal remains inactive (LOW), as shown in FIG. 7B. In an example shown in FIG. 7B, for the processor B, the instruction fetch (IF), decode (DE), and executing (EX) stages are executed in the memory access (ME) stage of the processor A. Following the memory access (ME) stage of the processor A, the memory access (ME) stage of the processor B is executed. That is, in the co-processor, following the memory access (COP ME) of an instruction issued by the processor A, decoding (COP DE) of an instruction issued by the processor B is performed.

In the case of the tightly coupled bus shown in FIG. 6A, a period (of delay) where the pipeline is stalled at a time of access contention is the period corresponding to one stage of the pipeline (which is the DE stage in FIG. 6A), for example. On contrast therewith, in the case of the loosely coupled bus in FIG. 7A, a period where the ME stage of the processor is stalled when access contention occurs is long. Especially when the speed of the bus cycle is low, the period where the ME stage is stalled is increased, thereby causing an idle period of the pipeline. In the case of the tightly coupled bus shown in FIG. 6A, an idling (vacancy) of the pipeline does not occur.

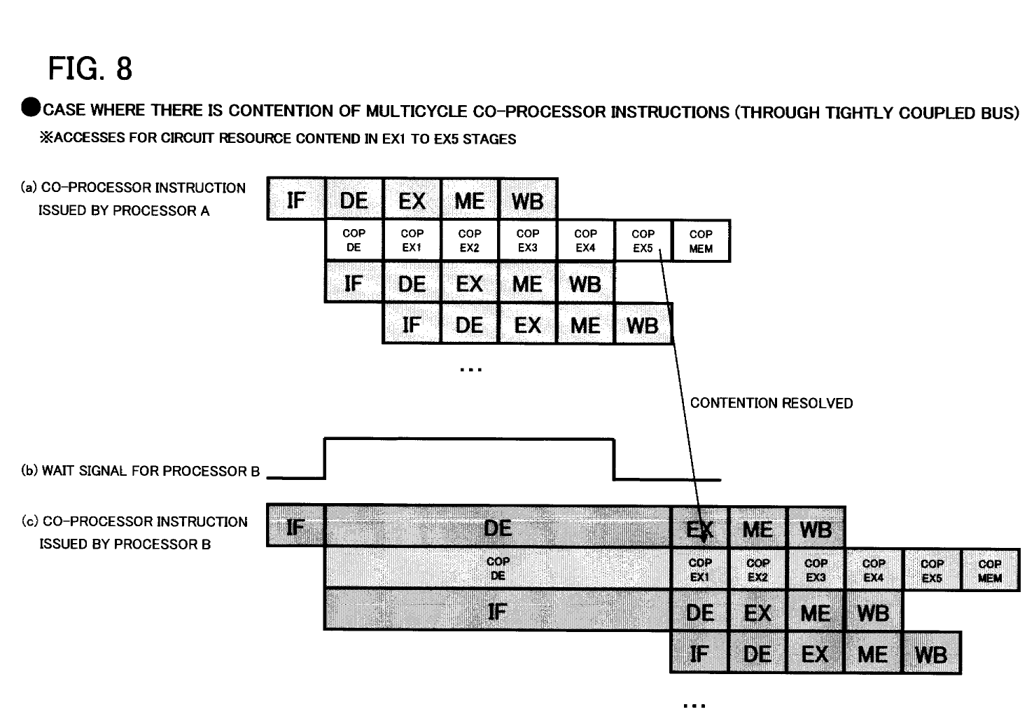

FIG. 8 is a diagram for explaining a case where co-processor instructions each with a plurality of cycles contend in the configuration that uses the co-processor in this example. The case where the co-processor instructions each with the plurality of cycles contend in the pipelines to be executed by the co-processor is shown. When an access to a resource to be used by a co-processor instruction from the processor B contends with pipeline operation executing stages (COP EX1 to EX5) in the co-processor that executes a co-processor instruction issued by the processor A, a WAIT signal is output from the arbitration circuit (indicated by reference numeral 115 in FIG. 1) to the processor B in this period. The decode (DE) stage of the co-processor instruction issued by the processor B in the co-processor is stalled. After completion of the operation executing stage (COP EX5) of the co-processor instruction issued by the processor A in the co-processor, the operation executing stages (COP EX1 to EX5) and the memory access (COP ME) stage of the co-processor instruction issued by the processor B are executed.

In this example, a description was given about the examples where arbitration (arbitration) control over resource contention is performed for each instruction pipeline stage. The arbitration may be performed for each instruction cycle, or access arbitration may be performed for every plurality of instructions, based on access contention for a resource.

In the examples described above, as the method of classifying the circuit resources in the co-processor by the ALUs and the register files to be handled by the RT level, hierarchical definition of the co-processor instructions that use the resources is made. For this reason, the following effects are achieved.

According to the first example, a plurality of the processors can individually access a circuit resource (such as a computing unit) in the tightly coupled co-processor. Efficient utilization (simultaneous use) of the resource becomes possible for each classified circuit.

According to the second example, as the method of classifying the circuit resources in the co-processor by the ALUs and the register files to be handled by the RT level, hierarchical definition of the extended co-processor instructions using the circuit resources is made. Then, arbitration of contention is performed for each hierarchically defined instruction as well as for each circuit resource. A higher-level solution to the contention thereby becomes possible.

Further, when a top-layer instruction is desired to be changed, a programming change using a medium-layer or a lower-layer instruction can be made (refer to FIG. 4). That is, a hardware change can be avoided.

Respective disclosures of Patent Document and Nonpatent Document described above are incorporated herein by reference. Within the scope of all disclosures (including claims) of the present invention, and further, based on the basic technical concept of the present invention, modification and adjustment of the exemplary example and the examples are possible. Further, within the scope of the claims of the present invention, a variety of combinations or selection of various disclosed elements are possible. That is, the present invention of course includes various variations and modifications that could be made by those skilled in the art according to all the disclosures including the claims and the technical concept.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A multiprocessor apparatus comprising:
a plurality of processors;
a co-processor provided in common to the processors and including a plurality of resources; and
an arbitration circuit that arbitrates contention among the processors for each resource or each hierarchy of a plurality of resources according to instructions issued to the co-processor from the processors.

2. The multiprocessor apparatus according to claim 1, wherein the co-processor variably sets connecting relationships among the resources in the co-processor according to the instructions issued to the co-processor from the processors.

3. The multiprocessor apparatus according to claim 1, wherein the processors are connected to the co-processor via a tightly coupled bus.

4. The multiprocessor apparatus according to claim 3, wherein under control by the arbitration circuit, simultaneous use of a plurality of mutually contention free resources on a same hierarchy or different hierarchies in the co-processor by the processors through the tightly coupled bus is allowed

5. The multiprocessor apparatus according to claim 1, wherein the co-processor variably sets connecting relationships among the resources in the co-processor according to the instructions issued to the co-processor from the processors.

6. The multiprocessor apparatus according to claim 1, wherein extended instructions that exclusively use one or a plurality of the resources in the co-processor are provided as an instruction set; and
when the extended instructions are simultaneously issued to the co-processor from the processors, contention on the basis of the one or the plurality of the resources corresponding to the extended instructions is subjected to arbitration by the arbitration circuit.

7. The multiprocessor apparatus according to claim 6, wherein the extended instructions include:
first-layer extended instructions corresponding unit functions of circuit resources, respectively; and
second-layer extended instructions each of which implements a predetermined function by combining a plurality of the circuit resources corresponding to the first-layer extended instructions.

8. The multiprocessor apparatus according to claim 7, wherein the extended instructions include:
third-layer extended instructions each of which implements a predetermined function by combining the circuit resources corresponding to the second-layer extended instructions.

9. The multiprocessor apparatus according to claim 6, wherein the co-processor comprises:
an interface circuit that interfaces with each of the processors through a tightly coupled bus;
a decoder that interprets a command supplied from the each of the processors through the tightly coupled bus;
a control circuit that controls a function of the co-processor according to a signal resulting from decoding of the command;
circuit resources including arithmetic circuits and register files; and
multiplexers arranged on input/output buses of the circuit resources;
the control circuit outputting a selection signal specifying connecting destinations of the multiplexers.
